(19) United States
(12) Patent Application Publication
(10) Pub. No.: US 2010/0025319 A1
(43) Pub. Date: Feb. 4, 2010

(54) DE-SLUDGING APPARATUS

(76) Inventors: Oiva SUUTARINEN, Espoo (FI); Kalle SUTTARINEN, Helsinki (FI)

Correspondence Address: BIRCH STEWART KOLASCH & BIRCH, PO BOX 747, FALLS CHURCH, VA, 22040-0747, US

(21) Appl. No.: 12/504,400

(22) Filed: Jul. 16, 2009

(30) Foreign Application Priority Data
Aug. 4, 2008 (FI) 20085761

(51) Int. Cl. B01D 43/00

(52) U.S. Cl. 210/248

(57) ABSTRACT

The invention concerns an apparatus for removing sludge accumulated on the surface of liquid from a basin, which the liquid fills and through which it flows, such as a flotation clarification basin. The apparatus (10) comprises a de-sludging chute (11), which is arranged in the basin and which functions over the entire range of level variations in the basin, or a corresponding de-sludging chute structure (11, 14), the topmost edge of which functions as a discharge edge (11a) for the sludge to be removed, and devices (12, 13) for transferring the sludge (a₁, a₂) from the liquid's surface (w₁, w₂) into the de-sludging chute (11) and further from the de-sludging chute over the discharge edge (11a) into a de-sludging basin, channel or other such and out of the clarification basin. The devices (12, 13) for transferring sludge are located in connection with the de-sludging chute (11) and they comprise an elongate, rotating shaft or a similar cylinder (12), the width of which is essentially equal to the de-sludging chute (11) and which extends in the horizontal direction and which is provided with transfer elements (13) attached to it. Under the effect of the rotating motion of the cylinder or the similar shaft (12) the transfer elements (13) will transfer along with them sludge (a₁, a₂) from the liquid's surface (w₁, w₂) and further out of the basin over the discharge edge, and in the area of the de-sludging chute (11, 14) and of the entire basin they allow height variations of the liquid level caused by different flow rates.

The invention concerns a de-sludging apparatus for removing sludge or other floating material accumulated on the surface of a liquid from a basin, channel or other such, which the liquid fills and through which it flows.

In greater detail, the invention concerns a de-sludging apparatus for removing sludge accumulated on the surface of a liquid from a basin or other such, which the liquid fills and through which it flows, which apparatus comprises a de-sludging chute or de-sludging chute structure, which is located in a basin or other such and the topmost edge of which functions as the discharge edge for the sludge to be removed, and devices for transferring the sludge from the surface of the liquid into the de-sludging chute and further over the discharge edge of the de-sludging chute into an outside sludge channel or other such out of the basin.

In water and sewage treatment plants there have been for decades various kinds of devices for removing floating sludge, such as chain, wire rope, bridge-type and cylinder plate scrapers, wire conveyors or overflow removal solutions. In all of these there is generally the drawback that their good functioning requires a certain height level for the liquid surface in the basin, in other words, it is not possible to change the liquid flow rate very much without adjusting the surface, or the devices are of a complicated and expensive structure. In overflow solutions there is the drawback of large waste water quantities, as is the case in some of the above-mentioned devices.

The apparatus according to the invention significantly simplifies, improves and makes more efficient the removal of floating sludge in water and sewage treatment plants, among other plants. It is mainly characterized in that in connection with the de-sludging chute and the sludge discharge edge extending above the top surface of the liquid in it there are de-sludging devices arranged, which comprise an elongate rotating cylinder or a similar shaft, which is essentially of the same width as the de-sludging chute and extends in the horizontal direction and which is equipped with transfer elements, which are attached to it and which under the effect of the rotating movement of said cylinder or a similar shaft will transfer along with them the sludge on the surface of the liquid and further out of the basin over the discharge edge of the de-sludging chute and which allow height changes of the liquid surface caused by different flow rates over the area of the de-sludging chute and the entire basin.

Thus, the surface level of the liquid to be treated may vary in the area between the lower and upper edge of the de-sludging chute located in a basin or other such within the limits allowed by the total efficiency of the treatment process of the basin or other such. No separate level control is needed as sludge accumulates at the same time on the liquid surface and in the chute. Thus, the transfer elements will under the effect of the rotating movement of said shaft or a similar cylinder transfer along with them the sludge located on or accumulating on the surface of the liquid and further out of the chute over its upper edge into the sludge channel or basin irrespective of at which height the surface of the liquid is in the area of the de-sludging chute.

The transfer elements attached to said rotating shaft or similar cylinder comprise at least one scraper plate, blade or other such, the length of which is essentially equal to the length of the de-sludging chute extending over the basin width and which extends mainly in the radial direction outwards from the horizontal axis of rotation of the shaft or a similar cylinder.

The de-sludging chute is essentially shaped as a part of a circular cylinder surface, so that as said shaft or a similar cylinder is rotating the outer edge of the scraper plate, blade or other such will follow the shape of the de-sludging chute.

The transfer elements may comprise two or more scraper plates, blades or other such distributed over the periphery of the shaft or similar cylinder. The scraper plates, blades or other such are preferably planar, chute-like or spiral. The edge of each scraper plate, blade or other such may be provided with a seal, which is made of a suitable material and with which the scraper plate, blade or other such is sealed against the surface of the de-sludging chute.

The apparatus according to the invention, which is equipped with a de-sludging chute and with de-sludging devices is most suitably formed as a uniform and integrated unit, which can be installed as a whole especially in water treatment works, in sewage treatment plants or in other such in connection with the clarification basin.

A de-sludging channel is suitably connected to the de-sludging apparatus.

The de-sludging apparatus according to the invention is very suitable and in every respect advantageous for use, for example, in water and sewage treatment plants using the flotation method. In regard to de-sludging devices which have been used previously its advantage in comparison with these is also especially obvious in de-sludging according to the vortex flotation method, in which surface loads may be over 45 m³/m²/h, so that the accumulation of sludge per square metre is great in a short time.

Since in the vortex flotation method it is advantageous to make the overflow edge for pure water and the overflow edge for sludge removal very long and the water flow distance short even owing to the technical flotation flow characteristics and structures, the sludge can moreover be removed very dry or diluted by controlling the water volume flowing along with the sludge with the aid of the tightness between the chute and the de-sludging blade. The advantages of the invention as regards flow and de-sludging are hereby significantly more pronounced.

De-sludging can be continuous or it may take place periodically, whereby the intervals and durations of de-sludging can be chosen for the most economic operations to take place suitably in relation to the impurities contained in the raw water, which is also especially important in sewage treatment. The quality and quantity of arriving sewage vary in these depending on whether it is day or night or whether the sewage is different industrial sewage, such as, for example, from a paper mill or a slaughterhouse. The apparatus according to the invention also allows great variations in the quantity of the arriving water to be treated, while the operation of the plant and the de-sludging will still remain free of disturbances. De-sludging will not either cause any flow peaks and it will not affect the result of the treatment.

The de-sludging apparatus at the same time functions as a water level equalizing and controlling device, so the overflow edge for treated water can be made fixed in the building stage without any need to adjust its height as the flow varies. Other advantages and characteristic features of the invention will emerge hereinafter from the detailed description of the invention.

In the following the invention will be described in detail by referring to some advantageous embodiments of the invention, which are shown in the figures of the appended drawing, but there is no intention to restrict the invention to these alone.

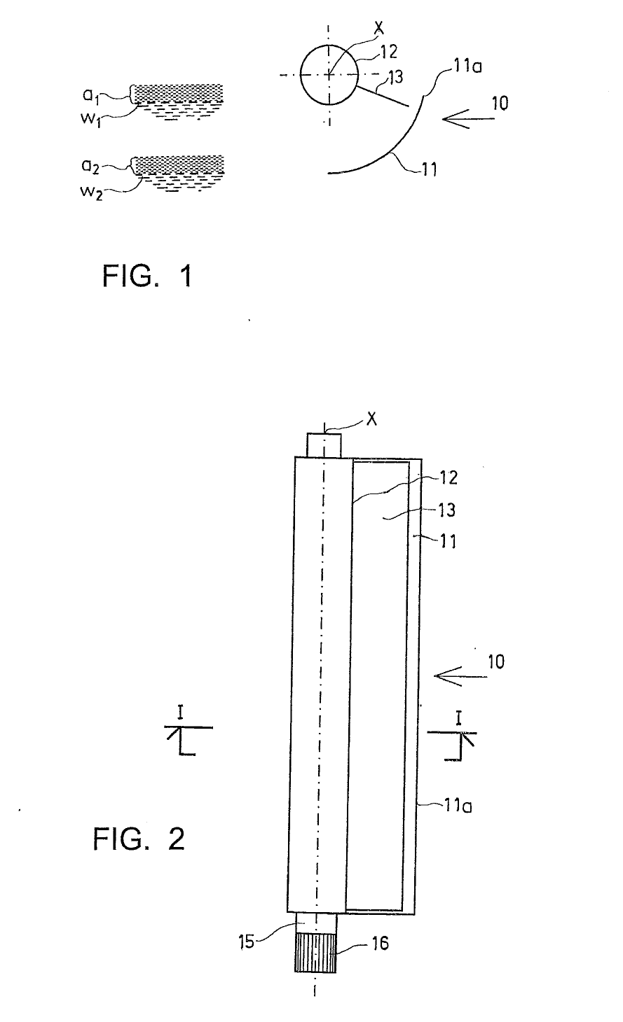

FIG. 1 is a cross-sectional view seen from the side of an embodiment of the de-sludging apparatus according to the invention corresponding to the cross-section taken at point I-I of FIG. 2.

FIG. 2 shows the apparatus according to FIG. 1 seen from above.

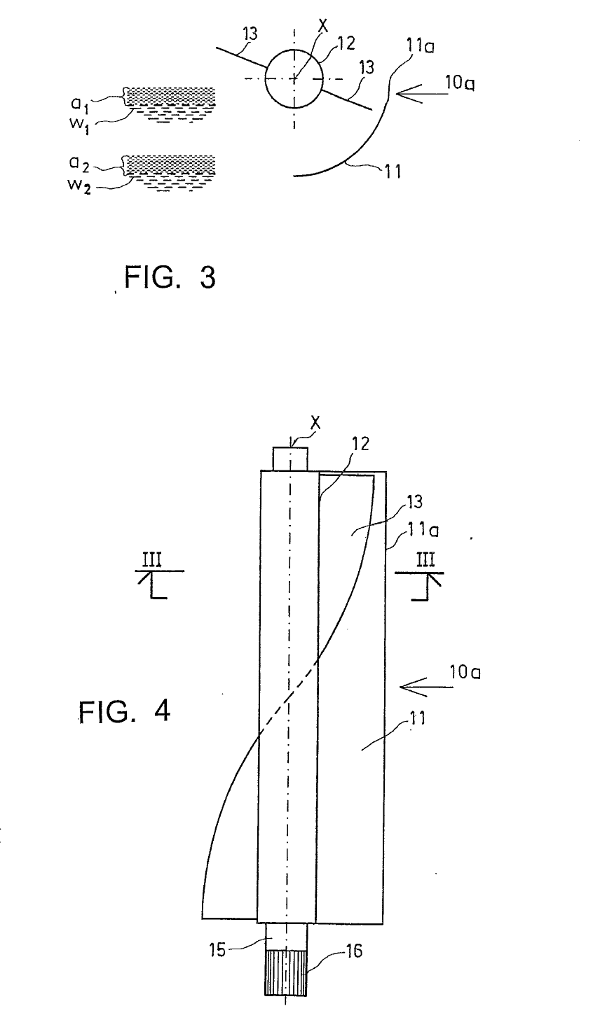

FIG. 3 is a cross-sectional view seen from the side of another alternative embodiment of the de-sludging apparatus according to the invention corresponding to the cross-section taken at point III-III of FIG. 4.

FIG. 4 shows the apparatus according to FIG. 3 seen from above.

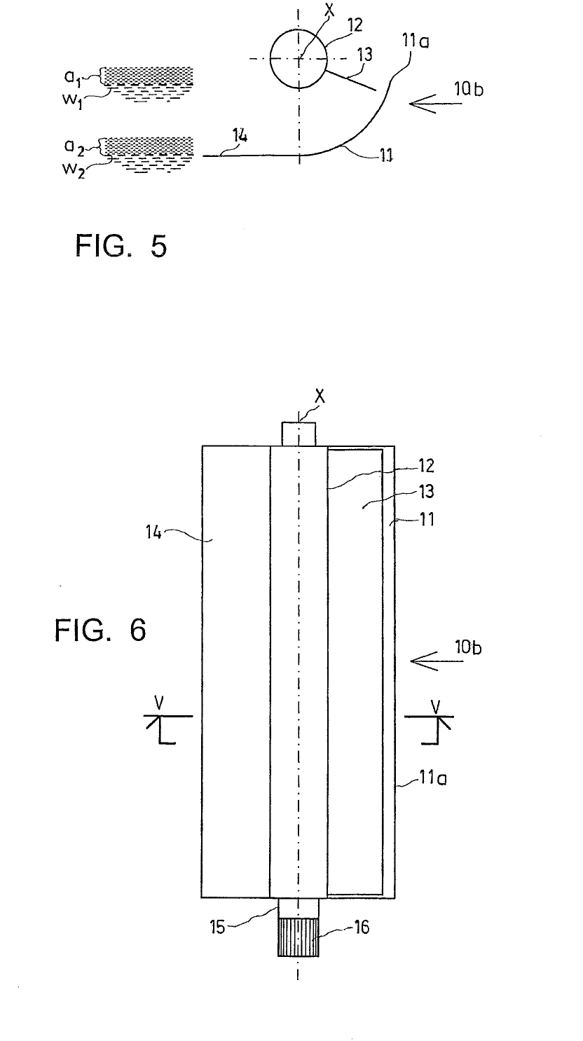

FIG. 5 is a cross-sectional view seen from the side of an alternative embodiment of the de-sludging apparatus according to the invention corresponding to the cross-section taken at point V-V of FIG. 6.

FIG. 6 shows the apparatus according to FIG. 5 seen from above.

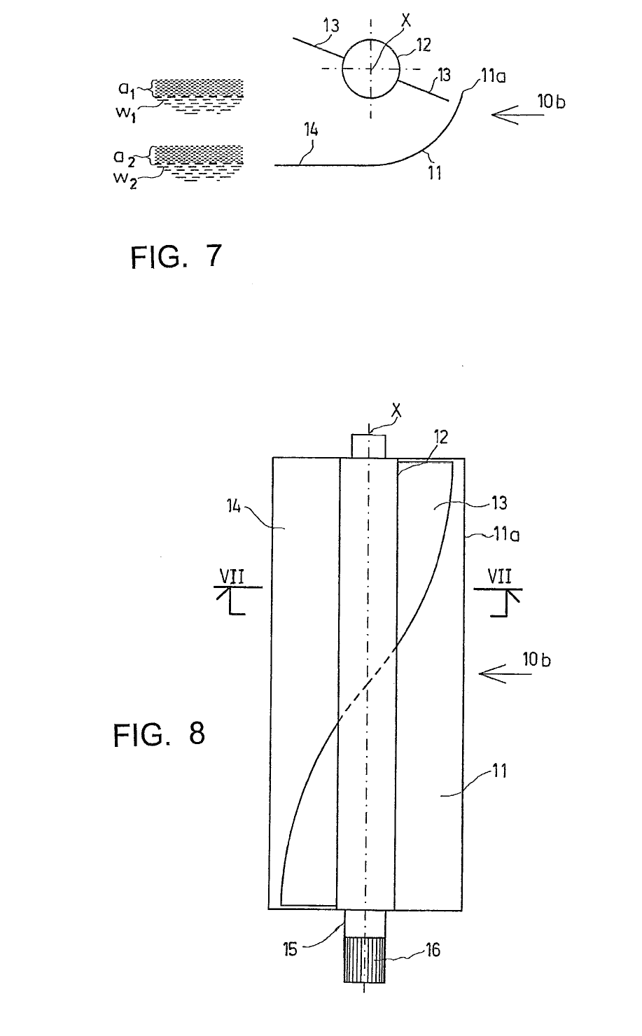

FIG. 7 is a cross-sectional view seen from the side of yet another alternative embodiment of the de-sludging apparatus according to the invention corresponding to the cross-section taken at point VII-VII of FIG. 8.

FIG. 8 shows the apparatus according to FIG. 7 seen from above.

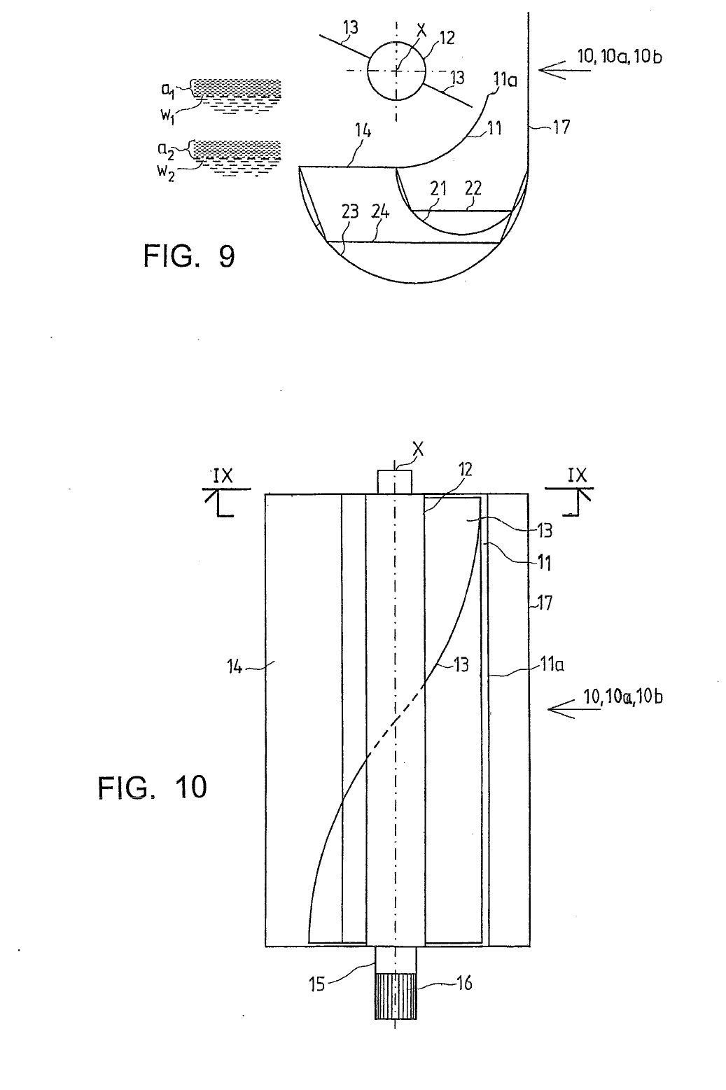

FIG. 9 is a cross-sectional view taken from the side of yet another alternative embodiment of the de-sludging apparatus according to the invention, which is a combination of the alternative embodiments shown in FIGS. 1-6, to which de-sludging channels are connected, and which cross-sectional view corresponds to the cross-section taken at point IX-IX of FIG. 10.

FIG. 10 shows the apparatus according to FIG. 9 seen from above.

In FIGS. 1 and 2 of the drawings, the general reference number 10 indicates a de-sludging apparatus according to the invention for removing sludge a₁, a₂, which has accumulated on the liquid's surface w₁, w₂, from a basin, such as a flotation clarification basin, which the liquid fills and through which it flows. The apparatus 10 according to FIGS. 1 and 2 comprises a de-sludging chute 11, which is located on the end wall of the basin or in the basin and which allows flow variations in the basin without any adjustment of the liquid level, and the topmost edge of the de-sludging chute 11 functions as a discharge edge 11a for the sludge to be removed. The figures of the drawing do not show the actual basin, in which the de-sludging apparatus 10 according to the invention is located. The de-sludging apparatus 10 further comprises devices 12, 13 for transferring the sludge a₁, a₂ from the liquid's surface w₁, w₂ through the de-sludging chute 11 over the discharge edge 11a into a de-sludging channel (17; FIG. 9), a sludge basin (not shown) or other such. Said devices for transferring the sludge a₁, a₂ are located in connection with the de-sludging chute 11 and they comprise an elongate, rotating cylinder 12 or a similar shaft, which is essentially of the same width as the de-sludging chute 11 and which extends in the horizontal direction and which is equipped with transfer elements 13 attached to it.

In the presentation of FIG. 1, the rotating body is explicitly a cylinder 12, and the transfer elements attached to it comprise at least one scraper plate 13, blade or other such, which is essentially of equal length as the cylinder 12 and which extends from the cylinder's horizontal axis of rotation X mainly in the radial direction outwards. The scraper plates 13 or similar blades will under the effect of the rotation of said cylinder 12 transfer along with them the sludge a₁, a₂ resting on the liquid's surface w₁, w₂ and further out of the basin irrespective of the height of the liquid's surface w₁, w₂ in the area of the de-sludging chute 11. Various heights of the liquid's surface and also of the sludge's surface are indicated in FIG. 1 by reference marks w₁, w₂ and a₁, a₂.

The de-sludging chute 11 belonging to apparatus 10 has essentially the shape of a part of a circular cylinder surface, so that when cylinder 12 is rotating the outer edge of scraper plate 13 or a similar blade will follow the shape of the de-sludging chute 11. FIGS. 1 and 2 show only one scraper plate 13, but if required there can be two or more such scraper plates 13 or similar blades distributed along the periphery of cylinder 12. In the embodiment shown in FIGS. 1 and 2, the scraper plate 13 is planar. For a sufficiently good tightening effect of the scraper plates 13 at the de-sludging stage as the sludge is being moved upwards along de-sludging chute 11, the edges of scraper plate 13 can be equipped with a seal (not shown), which is made of a suitable material and with which the scraper plate 13 is sealed against the surface of de-sludging chute 11.

The de-sludging devices consisting of a rotating cylinder 12 and of one or more scraper plates 13 as well as the de-sludging chute 11 can preferably be made as one uniform and integrated unit, for example, at an engineering workshop, and it can be mounted as such as a unit in its place resting on a ready-made wall structure, for example, in connection with the clarification basin in a water treatment plant.

Cylinder 12 is mounted on a shaft 15, which is rotating and supported in a fixed structure. Cylinder 12 may in its entirety be replaced by a mere shaft 15. Shaft 15 is further equipped with an appropriate drive or with a corresponding driving mechanism 16 for rotating the shaft 15.

FIGS. 3 and 4 show another embodiment of the invention, wherein the de-sludging apparatus is indicated by the general reference mark 10a. For those parts and components, which are identical to the embodiment shown in FIGS. 1 and 2, the same reference marks are used, and as regards these, reference is made as such to the description given above. From the embodiment described above the presentation in FIGS. 3 and 4 differs therein that in this embodiment the scraper blade 13 or similar blade is not level and planar but spiral. In this case too the spiral scraper plate 13 may be provided with a seal. In this embodiment too the scraper blade 13 or similar blade may be provided with a seal.

In the embodiment shown in FIGS. 5 and 6, the de-sludging apparatus is indicated by the general reference mark 10b. Also in the solution according to FIGS. 5 and 6 the same reference marks are used to indicate parts and components corresponding to the earlier embodiments, and they will not be described again in this context. In comparison with the earlier embodiments the solution shown in FIGS. 5 and 6 differs in that the de-sludging chute structure of the de-sludging apparatus 10b besides the mere de-sludging chute 11 also comprises a preceding planar or similar plate extension 14 for preventing any small particles that may have become separated from the sludge from flowing back.

In another embodiment shown in FIGS. 7 and 8, the de-sludging apparatus is indicated generally by reference mark 10b. Also in this embodiment the same reference marks are used to indicate parts and components corresponding to the earlier embodiments, and they will not be described again in this context.

The embodiment shown in FIGS. 7 and 8 differs from the embodiment shown in FIGS. 5 and 6 only in that the shape of the scraper plate 13 or plates or of similar components is spiral, as in the solution shown in FIGS. 3 and 4.

In FIGS. 9 and 10, the de-sludging apparatuses 10, 10a, 10b shown in the earlier figures are drawn combined in the same figures. FIGS. 9 and 10 illustrate that to the de-sludging apparatus 10, 10a, 10b is connected a de-sludging channel 17, into which the scraper plate 13, scraper plates or other such transfer the sludge a₁, a₂ from the liquid's surface w₁, w₂ through de-sludging chute 11 over discharge edge 11a. As is shown especially in FIG. 9, the de-sludging channel 17 may have either a round or a level bottom. In FIG. 9, the reference marks 21, 22 mean such a solution of the de-sludging channel 17, which is connected to the structure of the de-sludging chute 11 of the de-sludging apparatuses 10, 10a shown in FIGS. 1-4. Reference mark 21 means a de-sludging channel 17 with a round bottom, whereas reference mark 22 means one with a level bottom. In a corresponding manner reference marks 23, 24 mean such a solution of the de-sludging channel 17, which is connected to the structure of the de-sludging chute of the de-sludging apparatuses 10b, which are shown in FIGS. 5-8 and which are equipped with a plate extension 14. Reference mark 23 means a de-sludging channel 17 with a round bottom, whereas reference mark 24 means one with a level bottom. All the bottom shapes of de-sludging channel 17 shown in FIG. 9 are only by way of example and their shapes may differ from those shown in the figure.

A common feature for all embodiments is, for example, that as a scraper plate 13 or similar blade it is possible alternatively to use a level, planar, chute-like or spiral structure.

De-sludging takes place as the cylinder 11 or similar shaft 15 of the de-sludging apparatus 10, 10a, 10b is rotating slowly around its axis X and the sludge scraper plate 13 or scraper plates are cutting a piece out of the sludge a₁, a₂ accumulated on the surface to move along with them, at the same time as some water located below is made to follow along. Scraper plate 13 transports the sludge a₁, a₂ and any accompanying water along the de-sludging chute 11 over its discharge edge 11a into the de-sludging channel 17 or other such. The rotation of the cylinder 12 or similar shaft 15 of the de-sludging apparatus 10, 10a, 10b can be brought about by a suitable drive 16, for example, by a frequency-controlled electric motor or one equipped with a gear, by a V-belt drive or a chain gear or by a direct drive, and the intervals and durations of operating periods can be controlled automatically or continuously depending on the quantity to be removed of the sludge bed accumulated of the sludge a₁, a₂.

During de-sludging, as the sludge scraper plate 13 or plates touch or otherwise move mechanically the sludge's a₁, a₂ surface, flakes may separate from the sludge's surface and they tend to begin sinking downwards towards the bottom. In the de-sludging according to the invention, these flakes will remain on the surface of the extension plate 14 of the de-sludging apparatus 10, 10a, 10b and the water flowing there or, for example, micro bubbles of the water-air bed extending deeply in vortex flotation will guide them to flow along with the discharging sludge and the water flowing along with it into the de-sludging chute 11, and no lower surface plate is required. In this manner they cannot upset the treatment result.

In the foregoing, the invention was described by way of example by referring to the examples shown in the figures of the appended drawing. Various embodiments of the invention may vary within the scope of the inventive idea defined in the appended claims.

1. De-sludging apparatus for removing sludge, which has accumulated on the surface of liquid, from a basin or other such, which is filled by the liquid and through which the liquid flows, which apparatus comprises a de-sludging chute or a de-sludging chute structure, which is placed in the basin or other such and the top edge of which functions as a discharge edge for the sludge to be removed, and devices for transferring the sludge from the liquid's surface into the de-sludging chute and further over the de-sludging chute's discharge edge into an outside sludge channel or other such out of the basin, wherein in connection with the de-sludging chute and its sludge discharge edge extending above the liquid's top surface there are de-sludging devices arranged, which comprise an elongate, rotating cylinder or a similar shaft, which is essentially as wide as the de-sludging chute and extends in the horizontal direction and which is equipped with transfer elements, which are attached to it and which under the effect of the rotating motion of said cylinder or a similar shaft will transfer along with them sludge located on the liquid's surface and further out of the basin over the de-sludging chute's discharge edge and which allow height variations of the liquid level caused by different flow rates in the area of the de-sludging chute and the entire basin.

2. Apparatus according to claim 1, wherein the transfer elements attached to the shaft or to a similar cylinder comprise at least one scraper plate, blade or other such, the length of which is essentially equal to the length of the de-sludging chute of a similar width as the basin, and which extends from the horizontal axis of rotation of the shaft or similar cylinder mainly in a radial direction outwards.

3. Apparatus according to claim 1, wherein the de-sludging chute is essentially shaped as a part of a circular cylinder surface, so that as said shaft or similar cylinder is rotating the outer edge of the scraper plate, blade or other such will follow the shape of the de-sludging chute.

4. Apparatus according to claim 1, wherein the transfer elements comprise two or more scraper plates, blades or other such distributed along the periphery of the shaft or similar cylinder.

5. Apparatus according to claim 1, wherein each scraper plate, blade or other such is planar or chute-like.

6. Apparatus according to claim 1, wherein each scraper plate, blade or other such is spiral.

7. Apparatus according to claim 1, wherein the edge of each scraper plate, blade or other such is provided with a seal, which is made of a suitable material and with which the scraper plate, blade or other such is sealed against the de-sludging chute's surface.

8. Apparatus according to claim 1, wherein the apparatus comprising the de-sludging devices and the de-sludging chute is formed as a uniform and integrated unit, which can be mounted as a whole in connection with a clarification basin.

9. Apparatus according to, wherein a de-sludging channel is connected to it.
